(19) United States
(12) Patent Application Publication
(10) Pub. No.: US 2009/0090331 A1
(43) Pub. Date: Apr. 9, 2009

(54) Volumetric Efficiency Based Lift Pump Control

(75) Inventor: Ross Dykstra Pursifull, Dearborn, MI (US)

Correspondence Address: ALLEMAN HALL MCCOY RUSSELL & TUTTLE, LLP, 806 S.W. BROADWAY, SUITE 600, PORTLAND, OR, 97205, US

(73) Assignee: FORD GLOBAL TECHNOLOGIES, LLC, Dearborn, MI (US)

(21) Appl. No.: 11/867,552

(22) Filed: Oct. 4, 2007

(51) Int. Cl. F02M 57/02; F02M 37/08; F04B 49/06

(52) U.S. Cl. 123/446; 123/497; 417/44.2

(57) ABSTRACT

As one example, a method of operating a fuel delivery system of a directly injected internal combustion engine including a plurality of in-cylinder direct fuel injectors, a higher pressure fuel pump and a lower pressure fuel pump is provided. The method comprises operating the lower pressure fuel pump and the higher pressure fuel pump to maintain a prescribed fuel pressure at the fuel injectors; and varying an amount of pump work that is provided by the lower pressure fuel pump relative to the higher pressure fuel pump responsive to an indication of the efficiency of the higher pressure pump.

### BACKGROUND AND SUMMARY

Some vehicle engine systems utilizing direct in-cylinder injection of fuel include a fuel delivery system that has multiple fuel pumps for providing suitable fuel pressure to the fuel injectors. As one example, a fuel delivery system can utilize an electrically driven lower pressure pump (i.e. lift pump) and a mechanically driven higher pressure pump arranged respectively in series between the fuel tank and the fuel injectors. In some cases, the lower pressure pump has been utilized in conjunction with a mechanical return-less fuel system whereby the fuel pressure provided by the lower pressure pump is governed by a mechanical bypass regulator (e.g. set at 65 to 80 psi).

The inventor herein has recognized that selecting the operating and control parameters of the lower pressure fuel pump can be difficult due to the various competing considerations and requirements of the fuel delivery system. For example, if the lower pressure fuel pump is operated to supply too much fuel pressure to the higher pressure fuel pump, fuel economy of the engine may be reduced, since the power output of the fuel pump is the product of fuel pressure and fuel flow. However, if the lower pressure fuel pump is operated to supply too little fuel pressure to the higher pressure fuel pump, the higher pressure fuel pump may be provided with fuel vapor, which can degrade engine performance.

One approach to address the above issues may include controlling the pressure provided by the lower pressure lift pump to a specific target pressure based on the operating conditions of the engine. However, if the fuel delivery system does not include a pressure sensor between the lower pressure pump and the higher pressure pump for providing fuel pressure feedback, control of the lower pressure pump may be inaccurate. Even if a pressure sensor was provided between the lower pressure pump and the higher pressure pump, sensor delays and sensor degradation may still result in inaccuracies in the lower pressure pump control. Furthermore, the addition of the fuel pressure sensor between the lower pressure fuel pump and the higher pressure fuel pump may add cost and complexity to the fuel delivery system.

In contrast, or in addition, to the above approach, the inventor has recognized that the control objective should not necessarily be to enforce a minimum pressure of the lower pressure fuel pump, but instead should be to operate the lower pressure fuel pump to provide just enough power (e.g. fuel volume flow and fuel pressure increase) to provide a target efficiency for the higher pressure fuel pump. Since the higher pressure fuel pump is typically operated to provide a greater fuel pressure increase than the lower pressure fuel pump, inefficiencies in the higher pressure pump can be of greater detriment to fuel economy than inefficiencies in the lower pressure fuel pump. Therefore, the lower pressure fuel pump can be provided with just enough power so that the higher pressure fuel pump can achieve a minimum volumetric efficiency, thereby increasing the overall fuel economy of the engine system.

As such, in one example, a method of operating a fuel delivery system of a directly injected internal combustion engine including a plurality of in-cylinder direct fuel injectors, a higher pressure fuel pump and a lower pressure fuel pump is provided. The method comprises operating the lower pressure fuel pump and the higher pressure fuel pump to maintain a prescribed fuel pressure at the fuel injectors; and varying an amount of pump work that is provided by the lower pressure fuel pump relative to the higher pressure fuel pump responsive to an indication of the efficiency of the higher pressure pump.

As another example, an engine system is provided, comprising an internal combustion engine including at least one combustion chamber; a direct in-cylinder fuel injector configured to inject fuel directly into the combustion chamber; a fuel system configured to deliver pressurized fuel to the injector via a lower pressure fuel pump and a higher pressure fuel pump; a control system configured to operate the lower pressure fuel pump and the higher pressure fuel pump to provide pressurized fuel to the direct in-cylinder injector and adjust the operating parameter of the lower pressure fuel pump responsive to an indication of efficiency of the higher pressure fuel pump.

In this way, operation of the lower pressure and higher pressure fuel pumps can be coordinated to provide the prescribed fuel pressure and volumetric flow rate of fuel to the engine, while also maintaining the efficiency of the higher pressure fuel pump to at least a prescribed level.

### BRIEF DESCRIPTION OF THE DRAWINGS

FIG. 1A shows a schematic depiction of an example engine system including a fuel delivery system.

FIG. 1B shows the higher pressure fuel pump in greater detail.

FIG. 2 shows an example control flow diagram.

FIG. 3 shows a flow chart depicting a method for controlling the example fuel system.

FIG. 4 shows a timeline depicting some of the control strategies described herein.

### DETAILED DESCRIPTION

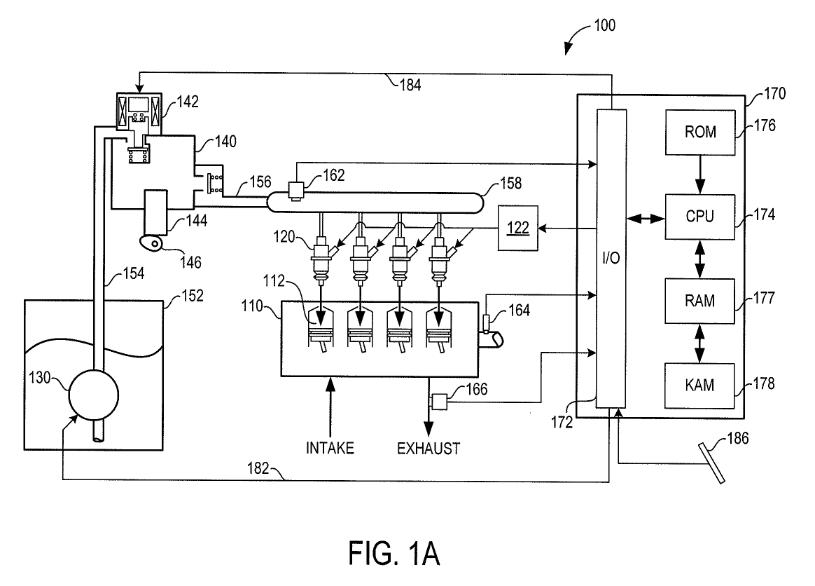

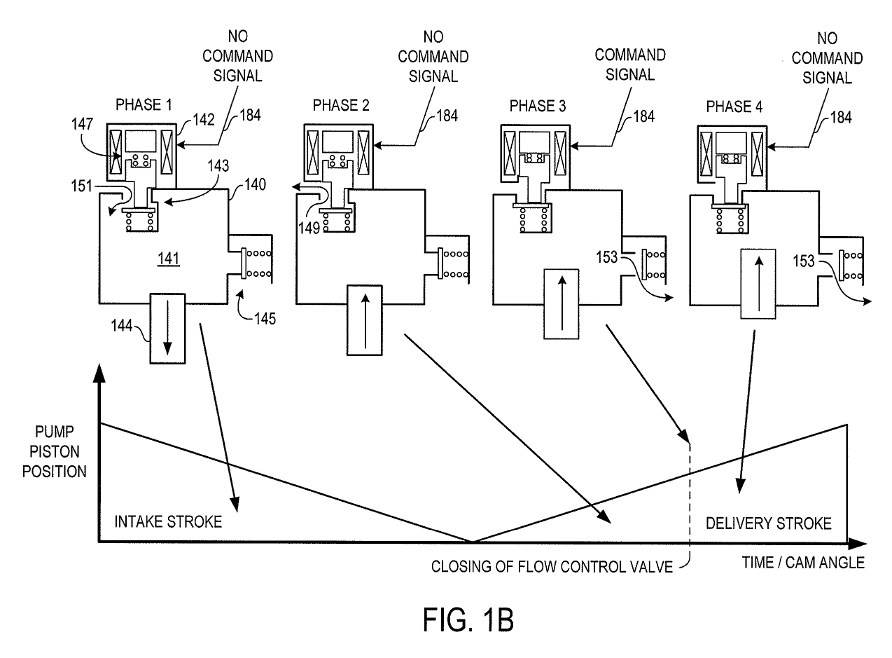

FIG. 1A shows an engine system 100, which may be configured as a propulsion system for a vehicle. Engine system 100 includes an internal combustion engine 110 having multiple combustion chambers or cylinders 112. Fuel can be provided directly to cylinders 112 via in-cylinder direct injectors 120. As indicated schematically in FIG. 1A, engine 110 can receive intake air and exhaust products of the combusted fuel. Engine 110 may include an suitable type of engine including a gasoline or diesel engine.

Fuel can be provided to engine 110 via injectors 120 by way of a fuel system indicated generally at 150. In this particular example, fuel system 150 includes a fuel storage tank 152 for storing the fuel on-board the vehicle, a lower pressure fuel pump 130, a higher pressure fuel pump 140, a fuel rail 158, and various fuel passages 154 and 156.

Lower pressure fuel pump 130 can be operated by a controller 170 to provide fuel to higher pressure fuel pump 140 via fuel passage 154. Lower pressure fuel pump 130 can be configured as what may be referred to as a lift pump. As one example, lower pressure fuel pump 130 can include an electric pump motor, whereby the pressure increase across the pump and/or the volumetric flow rate through the pump may be controlled by varying the electrical power provided to the pump motor, thereby increasing or decreasing the motor speed. For example, as the controller reduces the electrical power that is provided to pump 130, the volumetric flow rate and/or pressure increase across the pump may be reduced. The volumetric flow rate and/or pressure increase across the pump may be increased by increasing the electrical power that is provided to pump 130. As one example, the electrical power supplied to the lower pressure pump motor can be obtained from an alternator or other energy storage device on-board the vehicle (not shown), whereby the control system can control the electrical load that is used to power the lower pressure pump. Thus, by varying the voltage and/or current provided to the lower pressure fuel pump, as indicated at 182, the flow rate and pressure of the fuel provided to higher pressure fuel pump 140 and ultimately to the fuel rail may be adjusted by the controller.

Higher pressure fuel pump 140 can be controlled by controller 170 to provide fuel to fuel rail 158 via fuel passage 156. As one non-limiting example, higher pressure fuel pump 170 may be a BOSCH HDP5 HIGH PRESSURE PUMP, which utilizes a flow control valve (e.g. MSV) indicated at 142 to enable the control system to vary the effective pump volume of each pump stroke. However, it should be appreciated that other suitable higher pressure fuel pumps may be used. An example of the higher pressure fuel pump 140 is shown in described in greater detail with reference to FIG. 1B. Higher pressure fuel pump 140 can be mechanically driven by engine 110 in contrast to the motor driven lower pressure fuel pump 130. A pump piston 144 of higher pressure fuel pump 140 can receive a mechanical input from the engine crank shaft or cam shaft via cam 146. In this manner, higher pressure pump 140 can be operated according to the principle of a cam-driven single-cylinder pump.

Referring also to FIG. 1B, flow control valve 142 can include a magnetic actuator or solenoid indicated generally at 147, which controls an inlet valve 143 of the higher pressure pump. For example, flow control valve 142 can be configured to hold inlet valve 143 open with a spring force when it is not supplied with a driving current from controller 170. In other words, inlet valve 143 can be opened and closed via flow control valve 142 responsive control signal 184 received from controller 170.

During Phase 1 of the pump cycle, fuel can be entrained into a delivery chamber or cylinder plenum 141 as indicated at 151 via inlet valve 143 while the flow control valve is not energized and piston 144 is performing an intake stroke. Furthermore, during phase 1, the outlet valve 145 remains closed as the delivery chamber is filled with fuel.

During the delivery stroke, the flow control valve is operated by the controller to control the amount (e.g. volume) of fuel delivered during by the pump stroke. As shown by phase 2, if the flow control valve is open, which connects the delivery chamber of the pump and the low pressure side of the pump (e.g. fuel passage 154), the pressure in the delivery chamber is low and the fuel which remains in the delivery chamber is returned to the low pressure side of the pump without generating high pressure as indicated at 149. However, as shown by phase 3, if the flow control valve is closed during the delivery stroke by the controller initiating a command signal 184, thereby closing intake valve 143, the piston compresses the fuel contained in the delivery chamber during the delivery stroke. When the pressure in the delivery chamber increases above a certain value, the inlet valve is held closed by the fuel pressure within the delivery chamber and the command signal 184 provided by the controller can be withdrawn. When the pressure in the delivery chamber increases above the pressure present in the high pressure side of the pump (e.g. the fuel rail), the fuel can be conveyed through outlet valve 145 as indicated by 153 into fuel passage 156 and fuel rail 158 as demonstrated by phases 3 and 4. In order to regulate the conveyed volumetric flow during each pump stroke, the flow control valve can be closed by the controller at a prescribed angle before a top dead center position of piston 144.

In this way, controller 170 can vary the pressure increase across pump 140 and the volumetric flow rate of fuel provided by pump 140 to fuel rail 158 by varying the command signal indicated at 184. Thus, even when the higher pressure fuel pump is operated at a pump speed that is proportionally fixed to the speed of the engine, the controller can vary the fuel pressure increase and volumetric flow rate that is provided by the higher pressure pump.

Fuel rail 158 can include a fuel rail pressure sensor 162 for providing an indication of fuel rail pressure to controller 170. An engine speed sensor 164 can be used to provide an indication of engine speed to controller 170. The indication of engine speed can be used to identify the speed of higher pressure fuel pump 140, since pump 140 is mechanically driven by the engine, for example, via the crankshaft or camshaft. An exhaust gas sensor 166 can be used to provide an indication of exhaust gas composition to controller 170. As one example, sensor 166 may include a universal exhaust gas sensor (UEGO). Exhaust gas sensor 166 can be used as feedback by the controller to adjust the amount of fuel that is delivered to the engine via injectors 120. In this way, controller 170 can control the air/fuel ratio delivered to the engine to a prescribed setpoint.

Controller 170 can individually actuate each of injectors 120 via a fuel injection driver 122. Controller 170, driver 122, and other suitable engine system controllers can comprise a control system. While driver 122 is shown external to controller 170, it should be appreciated that in other examples, controller 170 can include driver 122 or can be configured to provide the functionality of driver 122. Controller 170, in this particular example, includes an electronic control unit comprising one or more of an input/output device 172, a central processing unit (CPU) 174, read-only memory (ROM) 176, random-accessible memory (RAM) 177, and keep-alive memory (KAM) 178.

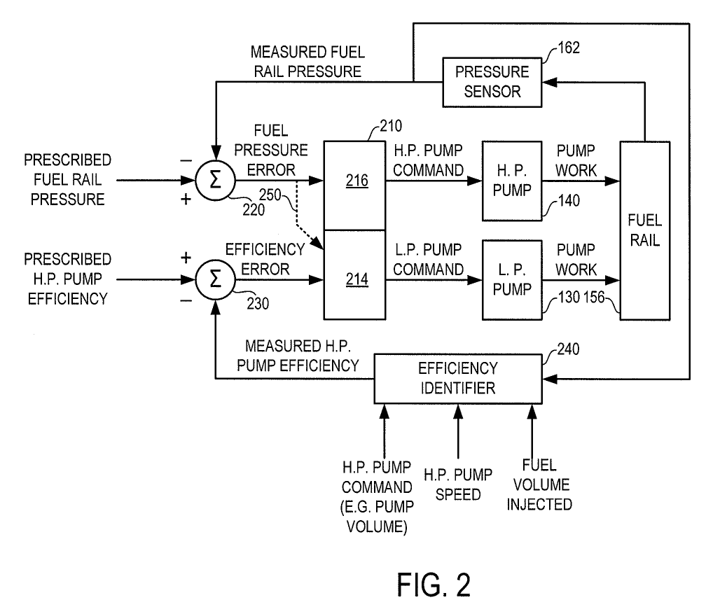

FIG. 2 shows a control diagram depicting an example control strategy for an engine system such as engine system 100 shown in FIG. 1A. It should be appreciated that the various control methods and routines described herein can be carried out by the control system including controller 170. FIG. 2 shows a controller 210 including a higher pressure fuel pump control portion 212 and a lower pressure fuel pump portion 214 for controlling the operation of pumps 140 and 130, respectively.

As one example, a prescribed fuel rail pressure can be compared at 220 to the measured fuel rail pressure (e.g. via sensor 162) to determine a fuel pressure error. The fuel pressure error can be used by controller 212 to identify and issue a higher pressure pump command to pump 140. The higher pressure pump 140 can provide pump work to the fuel that is received at fuel rail 156 based on the pump command, whereby the fuel rail pressure may be measured or identified by fuel pressure sensor 162. The measured fuel rail pressure can be utilized as feedback for the error determination at 220. In this way, the higher pressure fuel pump can be controlled to maintain a prescribed fuel rail pressure.

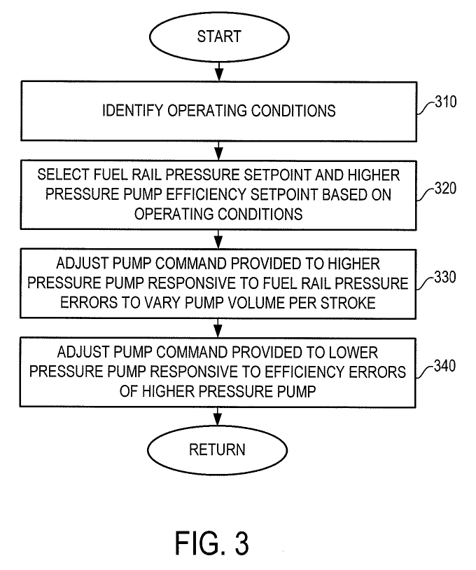

Additionally, a prescribed efficiency (e.g. volumetric efficiency) for the higher pressure fuel pump can be compared at 230 to the measured efficiency (e.g. volumetric efficiency) of the higher pressure fuel pump to determine an efficiency error. For example, the control system can store a prescribed efficiency value in memory for control of the higher pressure fuel pump. The efficiency error can be used by controller 214 to identify and issue a pump command for the lower pressure fuel pump 130. The lower pressure pump can also provide pump work to the fuel that is ultimately received at the fuel rail via the higher pressure fuel pump based on the pump command issued to the lower pressure pump, whereby the pump work provided by the lower pressure fuel pump is again manifested by the fuel rail pressure as identified by the fuel pressure sensor. Thus, feedback from the fuel pressure sensor, as well as an indication of the quantity of fuel injected, speed of the high pressure fuel pump or number of pump strokes performed within a given period of time, and the higher pressure pump command issued from 212 can be used to identify the efficiency of the higher pressure pump based on measured engine operating conditions as indicated at 240. This approach will be described in greater detail with reference to FIG. 3.

Furthermore, in some examples, the lower pressure pump can be controlled responsive to fuel pressure error feedback as indicated at 250 in addition to the efficiency error obtained from 230. For example, the lower pressure and higher pressure pumps can be controlled to respond at different rates to a fuel pressure error.

Thus, the control diagram of FIG. 2 shows how the lower pressure pump and the higher pressure pump can be controlled based on a prescribed fuel rail pressure and a prescribed pump efficiency of the higher pressure pump. Referring also to FIG. 3, a flow chart is shown depicting an example method for controlling the higher and lower fuel pumps of the engine system.

At 310, the operating conditions of the engine system can be identified. As one example, the control system can obtain operating condition information from various sensors including those described above with reference to FIG. 1A. Thus, the control system can obtain an indication of fuel rail pressure (e.g. via pressure sensor 162), an indication of the speed of the higher pressure pump (e.g. via engine speed sensor 164 or other suitable sensor), air/fuel ratio of exhaust gases (e.g. via exhaust gas sensor 166), and a requested engine output (e.g. via operator input device 186). The control system can also obtain the various ambient conditions including air temperature (e.g. via an air temperature sensor), air pressure (e.g. via an air pressure sensor), fuel temperature (e.g. via a fuel temperature sensor), etc. Further still, the control system can store values indicative of the pump command signals provided to the higher and lower pressure pumps, estimations of pump flow rates, etc.

At 320, a fuel rail pressure setpoint (i.e. a prescribed fuel rail pressure) can be selected based on the operating conditions identified at 310. As one example, the control system can vary the fuel rail pressure setpoint responsive to one or more operating conditions including engine speed, engine load, operator input (e.g. via device 186), fuel consumption rate, and various ambient conditions. For example, the fuel rail pressure setpoint can be selected by the control system based on a map stored in memory. As one non-limiting example, the fuel rail pressure may be selected so that the pulse width of the injectors can be maintained above a minimum pulse width for the desired fuel injection amount.

Additionally, at 320, an efficiency setpoint for the higher pressure fuel pump can be selected. Note that the efficiency setpoint can be a fixed value that may be stored in memory at the control system or can be varied by the control system responsive to operating conditions. For example, the efficiency setpoint can be varied responsive to pump temperature, pump speed, fuel temperature, or other ambient conditions. In an alternative embodiment, the routine may select set-points for selected pump parameters in such a way as to provide desired pump efficiency or effectiveness. For example, a desired volumetric or mass fuel flow for a given pressure increase across the pump can be selected. Further, still other variations may also be used.

As one non-limiting example, the control system can select a first fuel pressure increase across the lower pressure fuel pump and a second fuel pressure increase across the higher pressure fuel pump, which is grater than the first fuel pressure increase. The first and second fuel pressure increases can be selected so that the fuel pumps in combination provide the prescribed fuel rail pressure. Additionally, the control system can select a volume of fuel to provided through the higher pressure fuel pump, whereby the first fuel pressure increase provided across the lower pressure fuel pump can be adjusted in response to the selected volume of fuel flowing through the higher pressure fuel pump and the selected second fuel pressure increase to be provided by the higher pressure fuel pump.

At 330, the pump command provided to the higher pressure fuel pump (e.g. by the control system) can be adjusted responsive to the fuel rail pressure errors obtained from a comparison of the fuel rail pressure indication provided by sensor 162 and the selected fuel rail pressure setpoint as indicated at 220. As one non-limiting example, when the fuel rail pressure is less than the fuel rail pressure setpoint, the pump command provided to the higher pressure fuel pump can be adjusted to increase the effective volume per stroke of the higher pressure fuel pump, thereby increasing the fuel pressure at the fuel rail as previously described with reference to FIG. 1B. For example, the effective volume per stroke may be increased by advancing the timing of command signal 184 provided by controller 170 relative to the position of cam 146. However, when the fuel rail pressure is higher than the fuel pressure setpoint, the pump command can be adjusted to reduce the effective volume of the pump stroke or the pump stroke volume can be held constant in the case where the fuel injection rate is greater than the flow rate of fuel through the higher pressure pump. Note that the effective volume of fuel provided by each pump stroke can be reduced by retarding the timing of command signal provided by controller 170 relative to the position of cam 146.

At 340, the pump command provided to the lower pressure pump may be adjusted responsive to the error between the setpoint efficiency of the higher pressure pump and the actual efficiency of the higher pressure pump, as indicated at 230. The actual or measured efficiency of the higher pressure pump may be obtained by the controller from the various operating conditions identified at 310. As one example, the volumetric efficiency of the higher pressure pump may be identified by the following equation:

Pump Volumetric Efficiency=Actual Pump Volume Output/Nominal Pump Volume Output=((Rail Pressure Increase/Effective Modulus)+Fuel Volume Injected)/(Number of Pump Strokes*Pump Command*Maximum Volume Per Stroke)

The Fuel Pressure Increase term can be obtained from the fuel rail pressure sensor. For example, the control system can identify the magnitude and direction of the fuel rail pressure change over a given period of time. The Effective Modulus term can be a fixed value that is stored in memory at the control system. For example, the Effective Modulus can be in units of pressure divided by volume. As one non-limiting example, the Effective Modulus may be (1.5 MPa/0.25 cc). The Fuel Volume Injected term may be identified by the control system based on a combination of the fuel rail pressure and the pulse width delivered to each of the injectors via driver 122. Additionally, the prescribed mass of fuel to be injected into the cylinder and the estimated density of the fuel (e.g. based on fuel temperature) may be used to identify the volume of fuel injected. Further still, feedback from the exhaust gas sensor can be used to provide an indication of the amount of fuel that has been delivered to the engine over the given period of time. The Number of Pump Strokes term can be identified over the given period of time based on the speed of the pump higher pressure pump. Note that pump speed may be identified based on engine speed (or cam shaft speed) and a known speed ratio between the engine and the mechanically driven higher pressure pump. The Pump Command term can be identified as a portion of the maximum pump stroke that may be selected by the control system and the Maximum Volume Per Stroke term represents the maximum volume of fuel that can be handled by the higher pressure pump during a single stroke when the pump command is set to the maximum pump stroke. The maximum volume of fuel per pump stroke may be selected by the controller by initiating the command signal at 184 at a time that coincides with bottom dead center of pump piston 144. As one example, the Pump Command term can represent a fraction of the maximum pump stroke that may be provided to the higher pressure pump by the control system as indicated at 184. It should be appreciated that the operations described at 330 and 340 can be performed concurrently so that the control system utilizes a regressive approach to obtain the target values for the fuel rail pressure and the higher pressure pump efficiency.

In some examples, the control system may utilize a map stored in memory for identifying the efficiency of the higher pressure fuel pump based on the various operating conditions, thereby enabling the controller to adjust the pressure increase and volume flow rate provided by the lower pressure pump to control the efficiency of the higher pressure pump to a prescribed setpoint. While the lower pressure pump can be controlled based on the efficiency of the higher pressure pump, it should be appreciated that the lower pressure pump can also be controlled based on an indication of the volumetric flow rate of the higher pressure and the pressure increase across the higher pressure pump, since these values are also indicative of pump efficiency. Additionally, as previously described with reference to 250, control of the lower pressure pump may also be based upon the fuel pressure error obtained from 220.

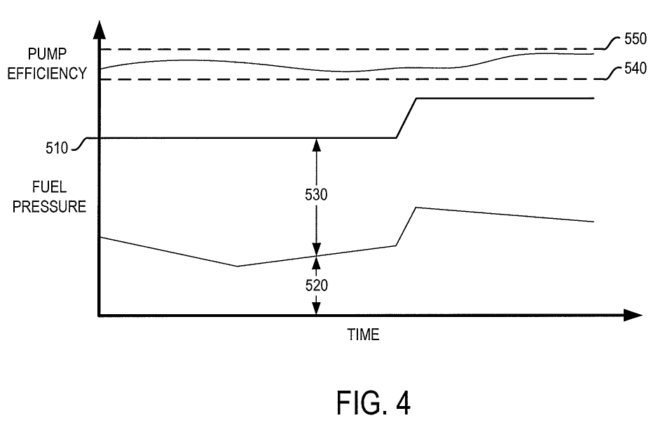

In this way, the volumetric efficiency of the higher pressure fuel pump and the fuel rail pressure can be obtained by the control system based on the operating conditions identified at 310 from the various sensors and known command signals issued by the controller. In response to the measured efficiency of the higher pressure pump and the fuel rail pressure, the control system can control the higher pressure pump and the lower pressure pump so that the prescribed higher pump efficiency and fuel rail pressure are obtained. By controlling the lower pressure pump so that the higher pressure pump maintains a minimum volumetric efficiency, the overall efficiency of the fuel supply system can be increased. As the higher pressure pump typically provides a greater fuel pressure increase than the lower pressure pump as shown in FIG. 4, the higher pressure pump often requires greater energy input. Therefore, efficiency gains in the higher pressure pump will typically dominate those of the lower pressure fuel pump.

FIG. 4 shows a timeline depicting an example fuel pump control operation. In this example, time is indicated along the horizontal axis and fuel pressure at various locations of the fuel delivery system and efficiency of the higher pressure pump are located along the vertical axis. The prescribed fuel rail pressure is indicated at 510, which includes a first pressure component indicated at 520 and a second pressure component indicated at 530. In this particular example, the first pressure component at 520 is due to the lower pressure pump and the second pressure component at 530 is due to the higher pressure pump. Thus, the fuel pressure increase that is provided by the lower pressure pump and the higher pressure pump are represented as 520 and 530, respectively. Note that in this particular example, the higher pressure pump is typically responsible for a greater portion of the pressure increase from the fuel tank to the fuel rail than the lower pressure pump. As can be observed from the operation of the lower pressure fuel pump indicated at 520, the lower pressure fuel pump is not necessarily controlled to a fixed pressure, but rather is controlled to maintain the prescribed efficiency for the higher pressure pump. For example, depending on the level of engine torque or speed of the engine (e.g. as requested by the vehicle operator), pump 130 may be controlled to provide a fuel pressure of 10 psi under some conditions, a fuel pressure of 100 psi under other conditions such as higher engine speeds, and may be controlled to provide a fuel pressure of 65 psi during idle after the vehicle has climbed a hill. Thus, the lower pressure fuel pump can be controlled to provide only enough pressure to keep the efficiency of the higher pressure pump above the prescribed efficiency threshold. In at least some examples, a pressure sensor need not be located between the lower pressure pump and the higher pressure pump for providing feedback to the lower pressure pump control since the lower pressure pump is not necessarily controlled to a pressure set-point, thereby enabling the pressure sensor to be omitted.

The maximum theoretical volumetric efficiency of the higher pressure pump is indicated at 550 and the minimum prescribed volumetric efficiency for the higher pressure pump is indicated at 540. As one non-limiting example, the minimum pump efficiency may include a volumetric efficiency of at least 80% or more specifically a volumetric efficiency of greater than 90%. As time increases along the horizontal axis, it can be observed in this example that the actual or measured efficiency of the higher pressure pump, indicated at 560, is maintained above the minimum prescribed pump efficiency by varying the relative amount of pump work provided by each of the lower and higher pressure pumps as represented by 520 and 530.

As indicated at 570, the prescribed pressure setpoint can be increased (e.g. responsive to a change in operating conditions), whereby the control system can respond by adjusting the pump command signal provided to the higher and lower pressure pumps to maintain the minimum prescribed efficiency of the higher pressure pump while also ensuring the prescribed fuel rail pressure is met. In some examples, the higher pressure fuel pump may be controlled to respond to lower frequency (larger longer term) fuel rail pressure fluctuations while the lower pressure fuel pump may be controlled to respond to higher frequency (smaller shorter term) fuel rail pressure fluctuations. However, in other examples, the lower pressure fuel pump may be controlled to respond to lower frequency fuel rail pressure fluctuations while the lower pressure fuel pump may be controlled to respond to higher frequency fuel rail pressure fluctuations.

Note that the example control and estimation routines included herein can be used with various engine and/or vehicle system configurations. The specific routines described herein may represent one or more of any number of processing strategies such as event-driven, interrupt-driven, multi-tasking, multi-threading, and the like. As such, various acts, operations, or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated acts or functions may be repeatedly performed depending on the particular strategy being used. Further, the described acts may graphically represent code to be programmed into the computer readable storage medium in the engine control system.

It will be appreciated that the configurations and routines disclosed herein are exemplary in nature, and that these specific embodiments are not to be considered in a limiting sense, because numerous variations are possible. For example, the above technology can be applied to V-6, I-4, I-6, V-12, opposed 4, and other engine types. The subject matter of the present disclosure includes all novel and nonobvious combinations and subcombinations of the various systems and configurations, and other features, functions, and/or properties disclosed herein.

The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method of operating a fuel delivery system of a directly injected internal combustion engine including a plurality of in-cylinder direct fuel injectors, a higher pressure fuel pump and a lower pressure fuel pump, the method comprising:
operating the lower pressure fuel pump and the higher pressure fuel pump to maintain a prescribed fuel pressure at the fuel injectors; and
varying an amount of pump work that is provided by the lower pressure fuel pump relative to the higher pressure fuel pump responsive to an indication of the efficiency of the higher pressure pump.

2. The method of claim 1, wherein the amount of pump work provided by the higher pressure pump is varied by adjusting a volume of fuel provided by each pump stroke and the amount of pump work provided by the lower pressure pump is varied by adjusting an amount of electrical power supplied to the lower pressure pump.

3. The method of claim 2, wherein the lower pressure pump is powered by an electric motor and the higher pressure pump is powered by the engine.

4. The method of claim 1, wherein the efficiency of the higher pressure pump includes a volumetric efficiency.

5. The method of claim 4, wherein the indication of volumetric efficiency is based on at least a volumetric flow rate of fuel through the higher pressure fuel pump and a pressure increase across the higher pressure fuel pump.

6. The method of claim 1, wherein the indication of efficiency is based on at least a speed of the higher pressure pump, a volume of each pump stroke of the higher pressure pump, a change in a fuel pressure provided by the higher pressure pump, and a rate at which fuel is injected into the engine by the fuel injectors.

7. An engine system, comprising:
an internal combustion engine including at least one combustion chamber;
a direct in-cylinder fuel injector configured to inject fuel directly into the combustion chamber;
a fuel system configured to deliver pressurized fuel to the injector via a lower pressure fuel pump and a higher pressure fuel pump;
a control system configured to operate the lower pressure fuel pump and the higher pressure fuel pump to provide pressurized fuel to the direct in-cylinder injector and adjust an operating parameter of the lower pressure fuel pump responsive to an indication of efficiency of the higher pressure fuel pump.

8. The system of claim 7, wherein the operating parameter includes an amount of electrical energy provided to the lower pressure fuel pump.

9. The system of claim 7, wherein the operating parameter includes a pressure increase across the lower pressure fuel pump.

10. The system of claim 7, wherein the operating parameter includes a level of pump work provided by the lower pressure fuel pump.

11. The system of claim 7, wherein the higher pressure fuel pump and the lower pressure fuel pump are arranged in series and wherein the higher pressure fuel pump is operated by being mechanically driven by the engine and the lower pressure fuel pump is operated by being driven by an electric motor.

12. The system of claim 7, wherein the control system is further configured to adjust an operating parameter of the higher pressure fuel pump to maintain a prescribed fuel pressure at the injector and wherein the control system is configured to adjust the operating parameter of the higher pressure pump by varying a timing of a command signal provided to a valve of the higher pressure pump.

13. The system of claim 12, wherein the control system is further configured to adjust the operating parameter of the lower pressure fuel pump to maintain the prescribed fuel pressure at the injector and wherein the control system is configured to adjust the operating parameter of the lower pressure fuel pump by varying a level of electrical power provided to a motor of the lower pressure fuel pump.

14. The system of claim 13, wherein the control system is further configured to adjust the operating parameter of the higher pressure fuel pump responsive to more rapid deviations of a pressure of the pressurized fuel from the prescribed pressure; and to adjust the operating parameter of the lower pressure fuel pump responsive to less rapid deviations of the pressure of the pressurized fuel from the prescribed pressure.

15. The system of claim 7, wherein the control system is configured to adjust the operating parameter of the lower pressure fuel pump to maintain the indication of the higher pressure fuel pump efficiency above a prescribed efficiency.

16. The system of claim 15, wherein the efficiency is a volumetric efficiency.

17. The system of claim 7, wherein the control system is further configured to vary a relative amount of pump work provided by each of the lower pressure fuel pump and the higher pressure fuel pump responsive to the indication of efficiency of the higher pressure fuel pump and an indication of fuel pressure within the fuel system between the higher pressure fuel system and the injector.

18. The system of claim 17, wherein the indication of fuel pressure in the fuel system is obtained by the control system from a fuel pressure sensor and wherein the indication of efficiency of the higher pressure fuel pump is based on a speed of the higher pressure pump, a stroke volume of the higher pressure pump, a change in the indication of fuel pressure, and a total volume of fuel injected into the engine.

19. A fuel delivery system for a directly injected internal combustion engine, comprising:
a fuel storage tank;
a fuel rail;
a fuel delivery passage coupling the fuel the fuel storage tank with the fuel rail;
an electrically driven lower pressure fuel pump arranged along the fuel delivery passage between the fuel storage tank and fuel rail;
a mechanically driven higher pressure fuel pump arranged along the fuel delivery passage between the lower pressure fuel pump and the fuel rail;
at least one direct in-cylinder injector communicating with the fuel rail; and
a control system configured to:
operate the lower pressure fuel pump to provide a first fuel pressure increase within the fuel delivery passage across the lower pressure fuel pump;
operate the higher pressure fuel pump to provide a second fuel pressure increase within the fuel delivery passage across the higher pressure fuel pump, greater than the first fuel pressure increase; and
adjust the first fuel pressure increase provided across the lower pressure fuel pump in response to a volume of fuel flowing through the higher pressure fuel pump and the second fuel pressure increase provided by the higher pressure fuel pump.

20. The system of claim 19, wherein the control system is configured to adjust the first fuel pressure increase provided across the lower pressure fuel pump by varying an amount of electrical power provided to the lower pressure fuel pump and wherein the higher pressure fuel pump is mechanically driven by the engine.
